(19) United States
(12) Patent Application Publication
(10) Pub. No.: US 2016/0101409 A1
(43) Pub. Date: Apr. 14, 2016

(54) CATALYSTS FOR RENEWABLE HYDROGEN PRODUCTION

(71) Applicant: PHILLIPS 66 COMPANY, Houston, TX (US)

(72) Inventors: William Chadwick Ellis, Bartlesville, OK (US); Uchenna Paul, Bartlesville, OK (US); Danielle Smith, Bartlesville, OK (US); Bruce B. Randolph, Bartlesville, OK (US); Neal D. McDaniel, Ochelata, OK (US); Jon Nelson, Bartlesville, OK (US); Larry Johnston, Nowata, OK (US)

(73) Assignee: PHILLIPS 66 COMPANY, Houston, TX (US)

(21) Appl. No.: 14/872,171

(22) Filed: Oct. 1, 2015

Related U.S. Application Data
(60) Provisional application No. 62/062,471, filed on Oct. 10, 2014.

(51) Int. Cl. B01J 23/89; C01B 3/40; B01J 23/83; B01J 23/755; B01J 23/78

(52) U.S. Cl. CPC B01J 23/892; B01J 23/755; B01J 23/78; B01J 23/83; C01B 3/40; C01B 2203/0233; C01B 2203/1058

(57) ABSTRACT

A catalyst for steam reforming. The catalyst comprises an active site of NiCu or NiCuZn, from about 15 wt % to about 25 wt % of the catalyst, a composition comprising at least one promoter and at least one support modifier, from about 5 wt % to about 30 wt % of the catalyst, and a support.

### CROSS-REFERENCE TO RELATED APPLICATIONS

This application is a non-provisional application which claims the benefit of and priority to U.S. Provisional Application Ser. No. 62/062,471 filed Oct. 10, 2014, entitled “Catalysts for Renewable Hydrogen Production,” which is hereby incorporated by reference in its entirety.

### STATEMENT REGARDING FEDERALLY SPONSORED RESEARCH OR DEVELOPMENT

None.

### FIELD OF THE INVENTION

This invention relates to catalysts for improved renewable hydrogen production from oxygenated feedstocks.

### BACKGROUND OF THE INVENTION

Today's refineries use large volumes of hydrogen for hydro-processing applications geared towards clean-fuels production and yield enhancements. Similarly, most biofuels processes require large volumes of hydrogen in order to produce drop-in fuels. In the past, refineries produced hydrogen primarily as a byproduct of catalytic naphtha reforming, a process for producing high-octane gasoline. However, increased processing of sour and heavy crudes, coupled with stricter environmental regulations, have significantly increased refinery hydrogen requirements. Consequently, most refineries today use steam methane reforming (SMR) to provide the supplemental hydrogen. Individual refinery hydrogen demand varies, depending on the crude slate and complexity. Although SMR is a matured technology, it has a significant carbon footprint. An average capacity SMR, 45 million standard cubic feet per day (MMSCFD) of hydrogen, generates around 59 pounds of CO₂/thousand standard cubic feet of hydrogen, excluding credits from steam export.

The CO₂ emission from the SMR comes from the steam reforming reaction and from the fuel combustion that provides the required heat for the reforming reaction. The fuel consists of natural gas and supplementary off-gas from the pressure swing absorber (PSA) used to separate the hydrogen produced from the other SMR process effluents. The PSA off-gas mostly consists of CO₂ (produced from the steam reforming reaction), CO, slip hydrogen, and un-reacted methane. In this configuration, all of the CO₂ from the unit (combustion and steam reforming) exits the process area as part of the flue gas via the furnace stack, where the residual CO₂ concentration is relatively dilute. In principle, conventional amine-based scrubber technologies could be employed to capture the CO₂ from the SMR. However this process is very expensive.

On the other hand, steam reforming of single or multi-component oxygenated bio-feeds having a molecular formula of CₓH_{y}O_{z} (where z/x ranges from 0.1 to 1.0 and y/z ranges from 2.0 to 3.0) could be an alternative source of low carbon hydrogen. However, at relevant reforming conditions, the longevity of conventional Ni-based reforming catalysts is significantly reduced during the reforming of bio-derived oxygenates, primarily due to the rapid formation of carbonaceous deposits.

There exists a need for formulations of relatively inexpensive catalysts that effectively pre-convert bio-derived oxygenates mostly to hydrogen, carbon dioxide, carbon monoxide, and methane with superior coking resistance relative to conventional reforming catalysts.

### BRIEF SUMMARY OF THE DISCLOSURE

A catalyst for steam reforming. The catalyst comprises an active site of NiCu or NiCuZn, from about 15 wt % to about 25 wt % of the catalyst, a composition comprising at least one promoter and at least one support modifier, from about 5 wt % to about 30 wt % of the catalyst, and a support.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts a representative steam methane reformer furnace.

FIG. 2 depicts a graph of temperature over time.

FIG. 3 depicts a graph of temperature over time.

FIG. 4 depicts a comparative graph of moles of carbon containing species in gas phase as a function of time on stream and temperature.

FIG. 5 depicts a comparative graph of hydrogen production as a function of time on stream and temperature

FIG. 6 depicts a comparative graph of carbon dioxide production as a function of time on stream and temperature.

FIG. 7 depicts a comparative graph of methane production as a function of time on stream and temperature.

FIG. 8 depicts a comparative graph of carbon monoxide production as a function of time on stream and temperature.

FIG. 9 depicts the evolution of H₂ as a function of temperature.

FIG. 10 depicts the evolution of CO₂ as a function of temperature.

FIG. 11 depicts the evolution of CO as a function of temperature.

FIG. 12 depicts the evolution of CH₄ as a function of temperature.

FIG. 13 depicts the evolution of H₂ as a function of temperature.

FIG. 14 depicts the evolution of CO₂ as a function of temperature.

FIG. 15 depicts the evolution of CO as a function of temperature.

FIG. 16 depicts the evolution of CH₄ as a function of temperature.

FIG. 17 depicts the evolution of H₂, CH₄, CO and CO₂ as a function of temperature.

FIG. 18 depicts the molar production rate of dominant gas phase carbon-containing species as a function of time on stream.

FIG. 19 depicts the performance of a catalyst during the conversion of a mixed oxygenate feed.

FIG. 20 depicts the average molar flow of gas phase production at different reaction temperatures.

FIG. 21 depicts the performance of a catalyst during the conversion of a mixed oxygenate feed.

FIG. 22 depicts the average molar flow of gas phase production at different reaction temperatures.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

The present embodiment discloses a catalyst for steam reforming. In one embodiment the catalyst comprises an active site of NiCu or NiCuZn, from about 15 wt % to about 25 wt % of the catalyst, a composition comprising at least one promoter and at least one support modifier comprising of at least two different elements, from about 5 wt % to about 30 wt % of the catalyst, and a support.

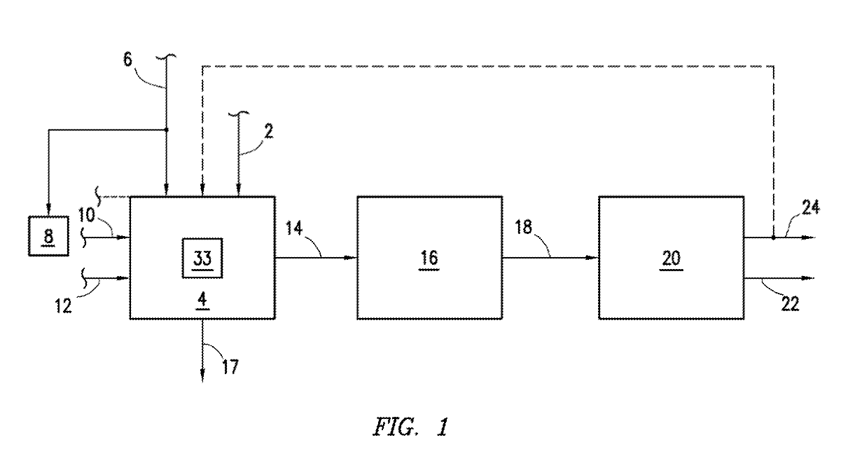

The use of the catalysts for steam reforming can be combined with any currently known method for steam reforming. FIG. 1 depicts a representative steam methane reformer furnace for which the catalysts can be used in this method wherein an oxygenated feed and steam is passed through catalyst-filled tubes. In this figure air 2 flows into a steam reformer 4 and is used to combust part of the oxygenated feed outside of the reformer tubes. While this figure depicts our method using a feed of solely oxygenated chemical compounds, other typical steam methane reformer furnace feeds can be used, either solely or combined with the oxygenated feed. Typical feeds used in steam methane reformer furnaces include light hydrocarbons, such as methane, naphtha, butane, natural gas, liquid petroleum gas, fuel gas, natural gas liquids, pressure swing absorber offgas, biogas, or even refinery feedstock.

In some designs the oxygenated feed 6 undergoes contaminants removal to remove contaminants such as sulfur prior to being fed into the steam reformer 4. In FIG. 1, the contaminate removal 8 can remove contaminates to produce a purified oxygenated feed 10. Additionally, steam 12, in this figure, can also be fed into the steam reformer 4.

Inside the steam reformer 4, a catalyst 33 reacts with both the purified oxygenated feed 10 and the steam 12 to produce both effluent gas 14 and flue gas 17. Optionally, the effluent gas 14 can be further reacted in reactor 16 to produce more hydrogen and carbon dioxide. The reaction that takes place in reactor 16 is typically a water-gas shift reaction to produce shifted effluent gas 18.

The shifted effluent gas 18 then undergoes pressure swing adsorption 20 wherein H₂ 22, is separated from the other product gases 24 consisting primarily CO₂, high BTU fuel gases, and other gases including nitrogen, argon or other chemicals and gases present in the original reaction from the steam reformer 4. A slipstream of these other gases 24 can flow back into the steam methane reformer furnace 4.

The catalysts of the present invention may be on any suitable support material. In one embodiment, the support material may be an inorganic oxide. In one embodiment, the support material may be selected from the group consisting of silica, alumina, titania, silica/alumina, calcium metasilicate, pyrogenic silica, high purity silica, zirconia, carbon, zeolites and mixtures thereof. In preferred embodiments, the support material is present in an amount from 25 wt. % to 99 wt. %, e.g., from 30 wt. % to 98 wt. % or from 35 wt. % to 95 wt. %.

The morphology of the support material, and hence of the resulting catalyst composition, may vary widely. In some exemplary embodiments, the morphology of the support material and/or of the catalyst composition may be pellets, extrudates, spheres, spray dried microspheres, rings, pentarings, trilobes, quadrilobes, multi-lobal shapes, or flakes although cylindrical pellets are preferred.

In one embodiment the active site of the catalyst can comprise, consist or consist essentially of NiCu or NiCuZn, from about 12 wt % to about 25 wt % of the catalyst. In one example the Ni can range from 12 wt % to 14 wt % of the catalyst or even 13 wt % of the catalyst. In one example the Cu can range from 4 wt % to 6 wt % of the catalyst or even 5 wt % of the catalyst. In yet another example the Zn can range from 0 wt % to 1 wt % of the catalyst, 1 wt % to 3 wt % of the catalyst or even 2 wt % of the catalyst.

In another embodiment the composition comprising the at least one promoter and the at least one support modifier can comprise of at least two different elements from about 5 wt % to about 30 wt % of the catalyst. In other embodiments the composition can comprise of at least three different elements. The three different elements can be either one promoter and two different support modifiers or even two different promoters and one support modifier.

The different types of elements that the composition, comprising at least one promoter and the at least one support modifier, can be include alkaline earth metals, alkali metals or even rare earth elements. In different embodiments it is possible that the composition is a combination of one alkaline earth metal, one alkali metal and one rare earth element. In other embodiments it is possible that the composition is multiple elements chosen from alkaline earth metals, alkali metals or rare earth elements.

The different types of alkaline earth metals that the composition, comprising at least one promoter and the at least one support modifier, can be chosen from include beryllium, magnesium, calcium, strontium, barium and radium. In one embodiment the composition comprises an alkaline earth metal from about 0.1 wt % to about 5 wt % of the catalyst, from about 0.1 wt % to about 2 wt % of the catalyst or even 0.8 wt % of the catalyst.

The different types of alkali metals that the composition, comprising at least one promoter and the at least one support modifier, can be chosen from include lithium, sodium, potassium, rubidium, caesium and francium. In one embodiment the composition comprises an alkali metal from about 0.1 wt % to about 5 wt % of the catalyst, from about 0.1 wt % to about 2 wt % of the catalyst or even 1 wt % of the catalyst.

The different types of rare earth elements that the composition, comprising at least one promoter and the at least one support modifier, can be chosen from include scandium, yttrium, lanthanum, cerium, praseodymium, neodymium, promethium, samarium, europium, gadolinium, terbium, dysprosium, holmium, erbium, thulium, ytterbium, and lutetium. In one embodiment the composition comprises a rare earth element from about 13 wt % to about 23 wt % of the catalyst, from about 17 wt % to about 19 wt % of the catalyst or even 18 wt % of the catalyst.

The following examples of certain embodiments of the invention are given. Each example is provided by way of explanation of the invention, one of many embodiments of the invention, and the following examples should not be read to limit, or define, the scope of the invention.

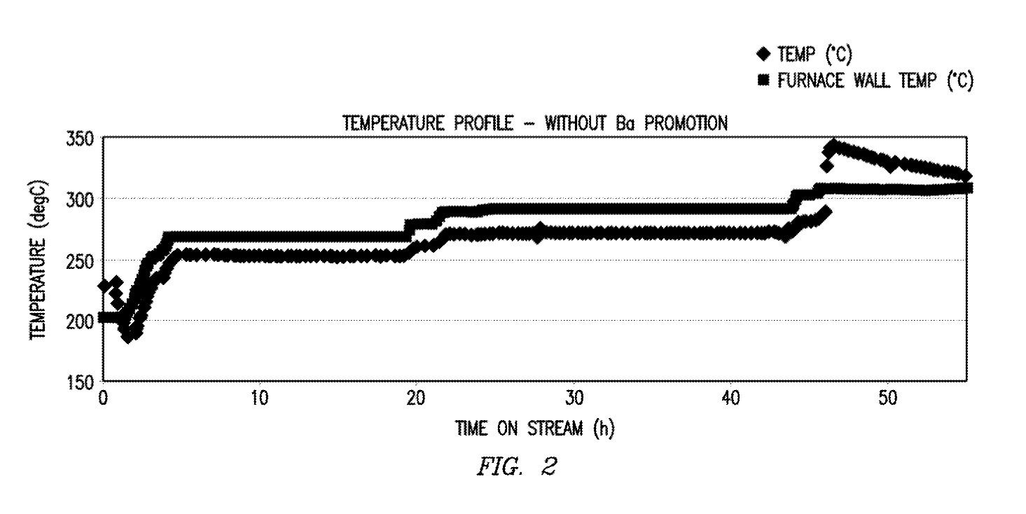

FIG. 2 depicts a graph of temperature over time for a catalyst comprising 26Ni10Cu1Au15MgOAL. The pressure for this test was run at 350 psig with a H₂ inlet of 0 mL/min and a N₂ inlet of 500 mL/min. The liquid feed for this test was 0.25 mL/min with a propanediol waste of H₂O/C of 3.

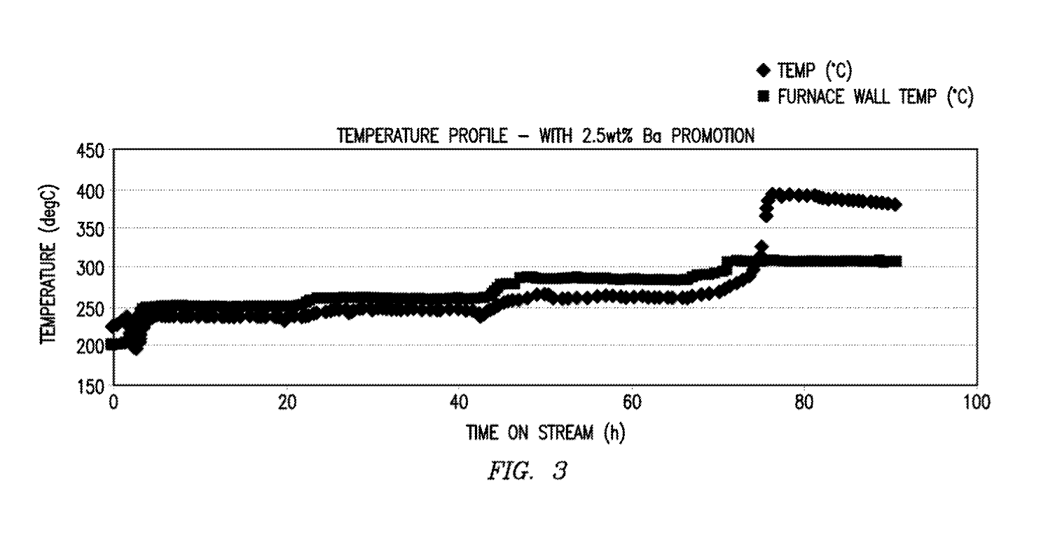

FIG. 3 depicts a graph of temperature over time for a catalyst comprising 26Ni10Cu1Au2.5Ba15MgOAL. The pressure for this test was run at 350 psig with a H₂ inlet of 0 mL/min and a N₂ inlet of 500 mL/min. The liquid feed for this test was 0.25 mL/min with a propanediol waste of H₂O/C of 3.

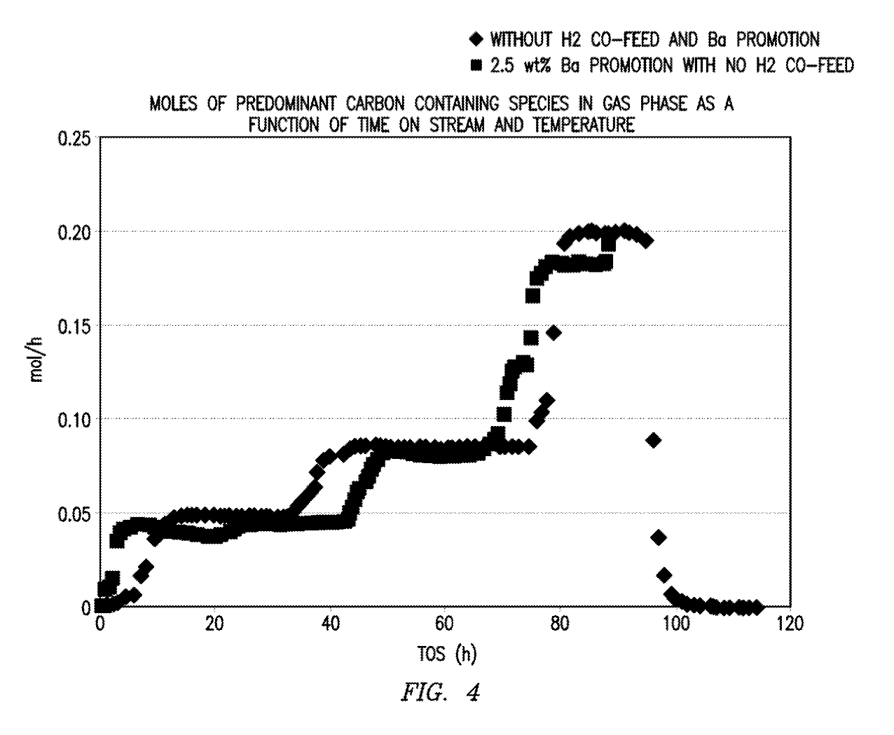

FIG. 4 depicts a comparative graph of moles of carbon containing species in gas phase as a function of time on stream and temperature. The graph compares the difference between not having H₂ as a co-feed and barium promotion on a catalyst and having H₂ as a co-feed with 2.5 wt % of a barium promotion on a catalyst.

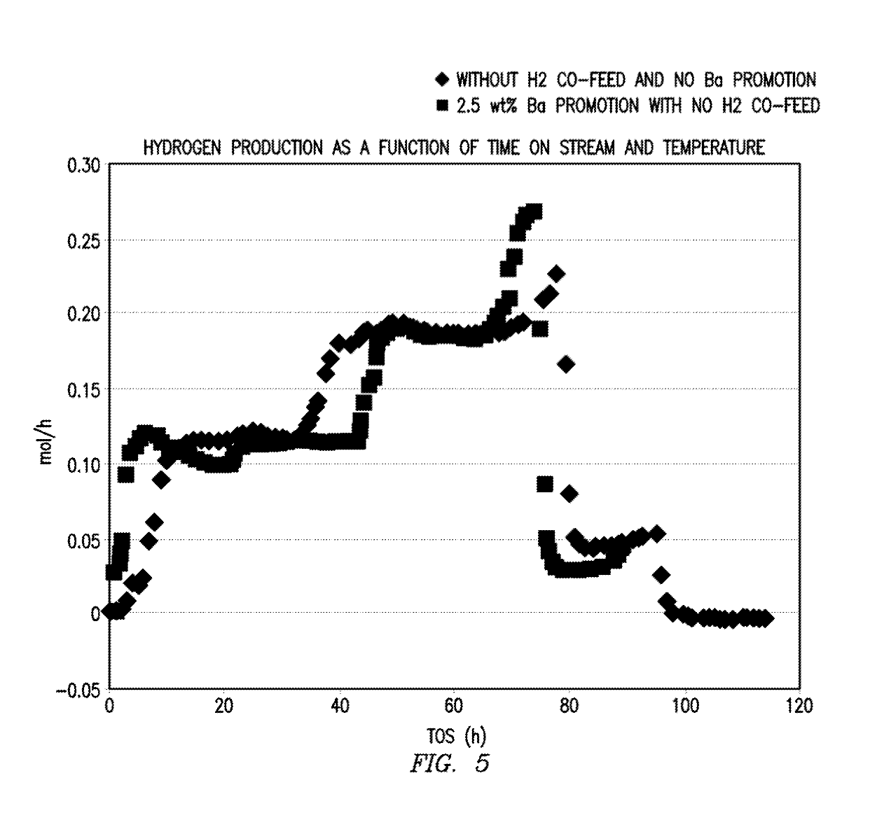

FIG. 5 depicts a comparative graph of hydrogen production as a function of time on stream and temperature. The graph compares the difference between not having H₂ as a co-feed and barium promotion on a catalyst and having H₂ as a co-feed with 2.5 wt % of a barium promotion on a catalyst.

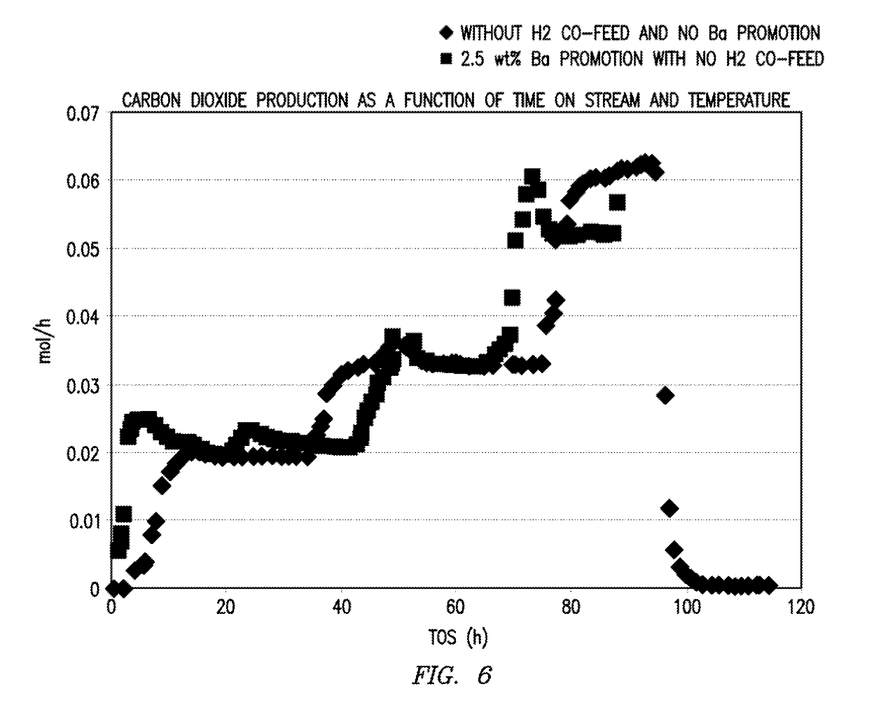

FIG. 6 depicts a comparative graph of carbon dioxide production as a function of time on stream and temperature. The graph compares the difference between not having H₂ as a co-feed and barium promotion on a catalyst and having H₂ as a co-feed with 2.5 wt % of a barium promotion on a catalyst.

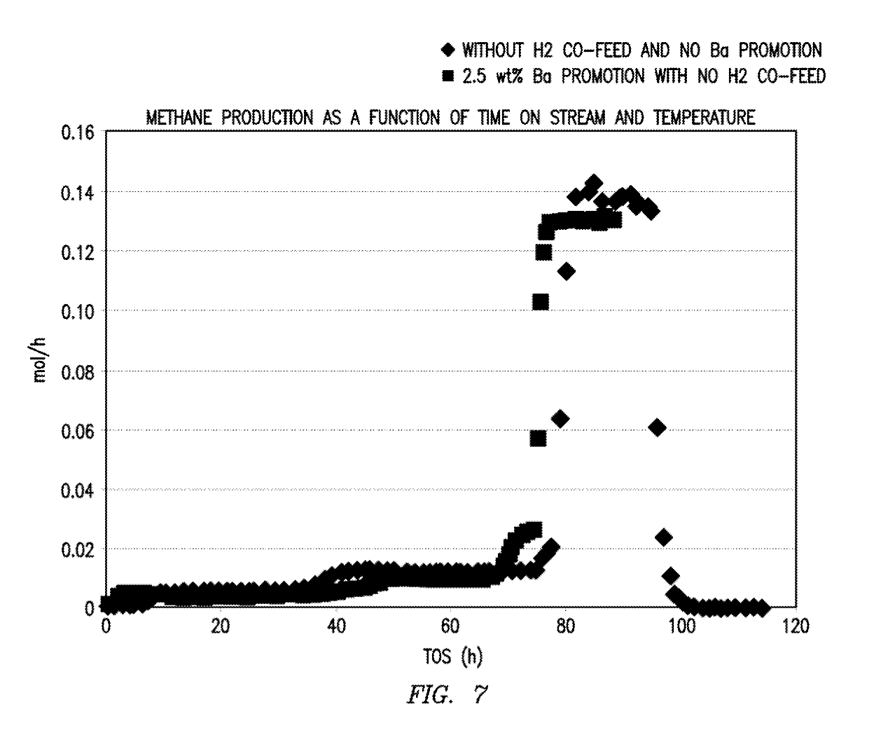

FIG. 7 depicts a comparative graph of methane production as a function of time on stream and temperature. The graph compares the difference between not having H₂ as a co-feed and barium promotion on a catalyst and having H₂ as a co-feed with 2.5 wt % of a barium promotion on a catalyst.

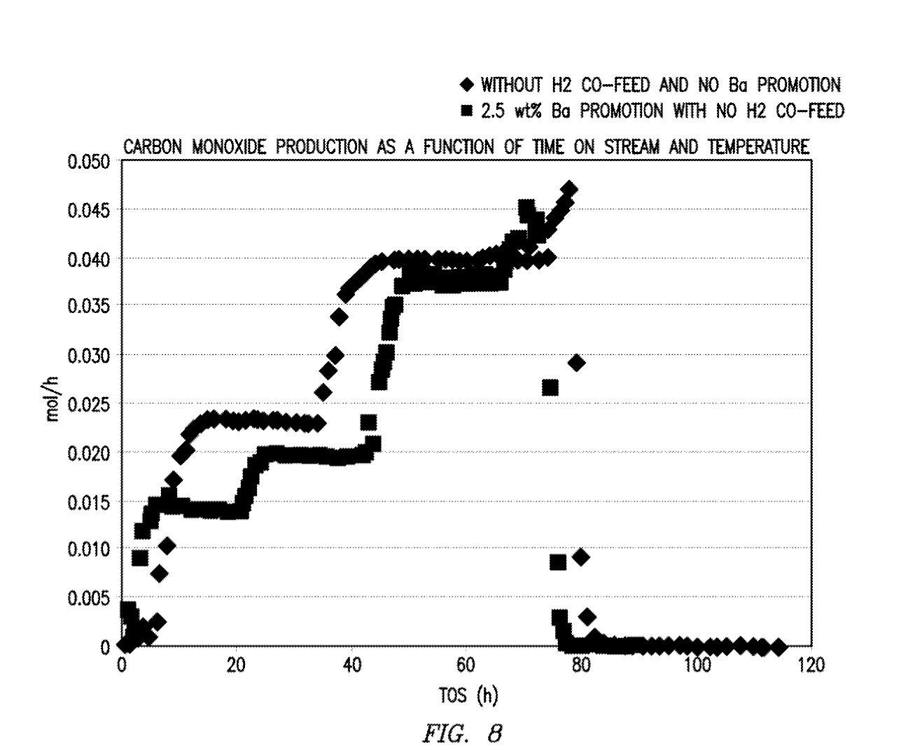

FIG. 8 depicts a comparative graph of carbon monoxide production as a function of time on stream and temperature. The graph compares the difference between not having H₂ as a co-feed and barium promotion on a catalyst and having H₂ as a co-feed with 2.5 wt % of a barium promotion on a catalyst.

### EXAMPLE 1

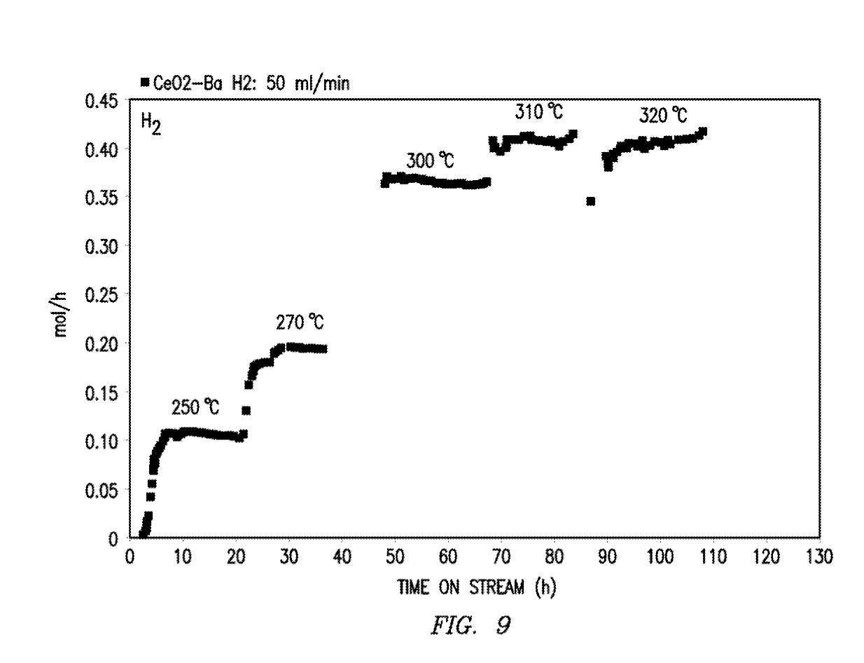

26Ni10Cu1Au1K15CeO₂Al2.5Ba, consisting of 26 wt % Ni, 10 wt % Cu, 1 wt % Au, 1 wt % K, 15 wt % CeO₂, 2.5 wt % Ba and balance Al₂O₃ was used to reform a mixture of aqueous oxygenates containing methanol, ethanol, and isopropanol to produce H₂, CH₄, CO and CO₂. FIGS. 9 through 12 depict the evolution of H₂, CH₄, CO and CO₂ as a function of temperature during the reforming of a mixture of aqueous oxygenates over 26Ni10Cu1Au1K15CeO₂Al2.5Ba, indicating reasonable catalytic activity at temperatures below 650K. The operating pressure was 300 psig, the liquid feed rate was 0.25 ml/min, the feed hydrogen was at 50 ml/min, the feed nitrogen was 450 ml/min, the weight of the catalyst was 4 grams, and the steam to carbon ratio was maintained at 3.

FIG. 9 depicts the evolution of H₂ as a function of temperature during the reforming of a mixture of aqueous oxygenates over 26Ni10Cu1Au1K15CeO₂Al2.5Ba.

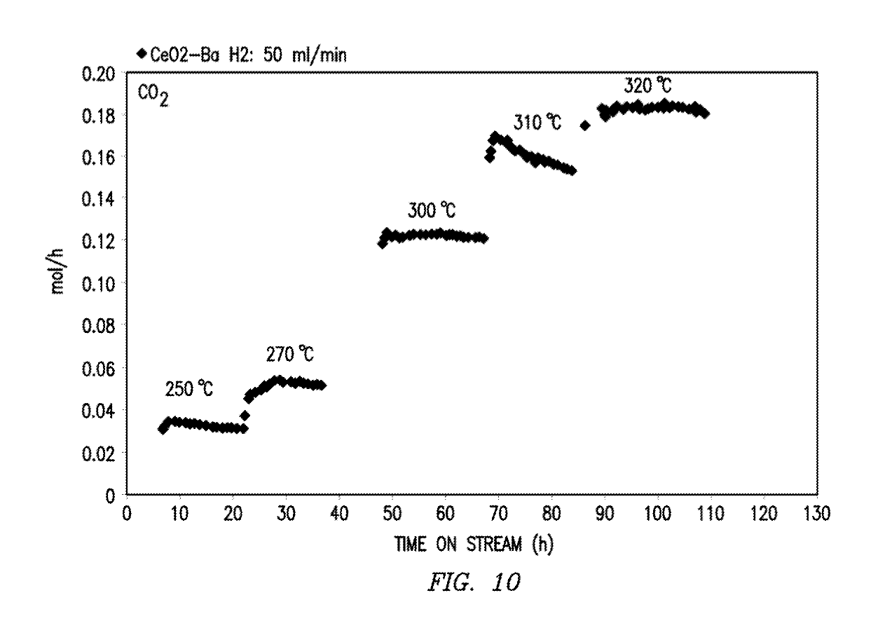

FIG. 10 depicts the evolution of CO₂ as a function of temperature during the reforming of a mixture of aqueous oxygenates over 26Ni10Cu1Au1K15CeO₂Al2.5Ba.

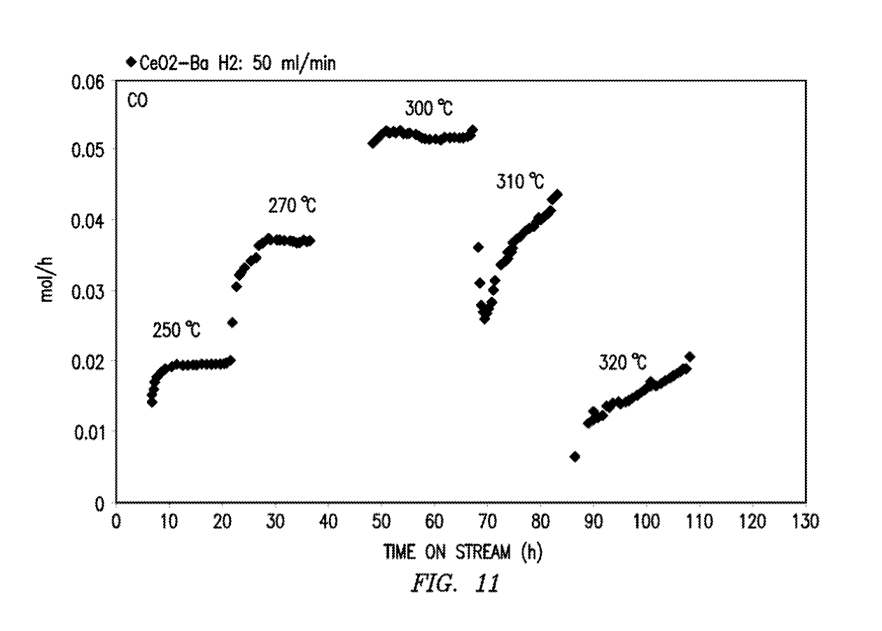

FIG. 11 depicts the evolution of CO as a function of temperature during the reforming of a mixture of aqueous oxygenates over 26Ni10Cu1Au1K15CeO₂Al2.5Ba.

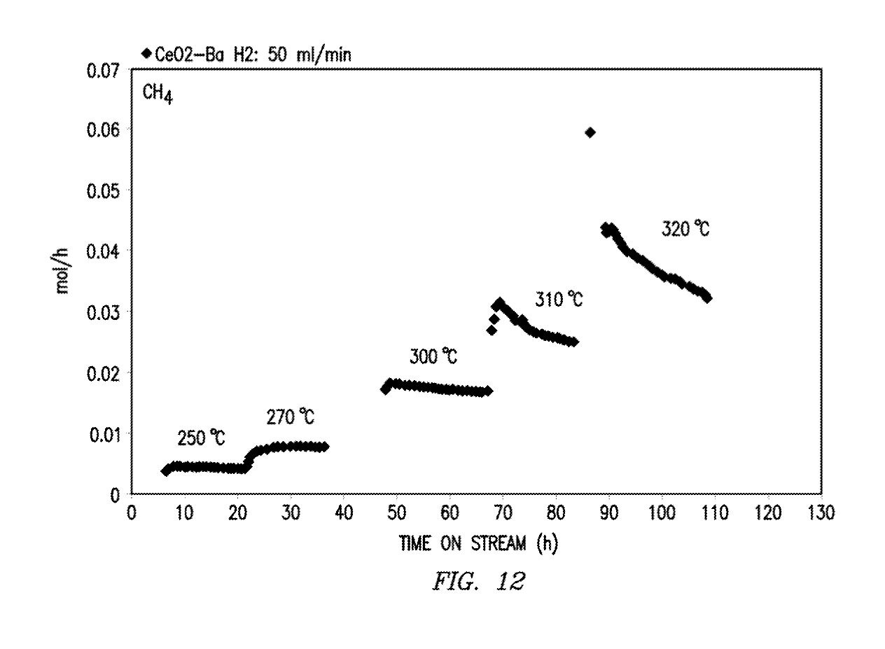

FIG. 12 depicts the evolution of CH₄ as a function of temperature during the reforming of a mixture of aqueous oxygenates over 26Ni10Cu1Au1K15CeO₂Al2.5Ba.

### EXAMPLE 2

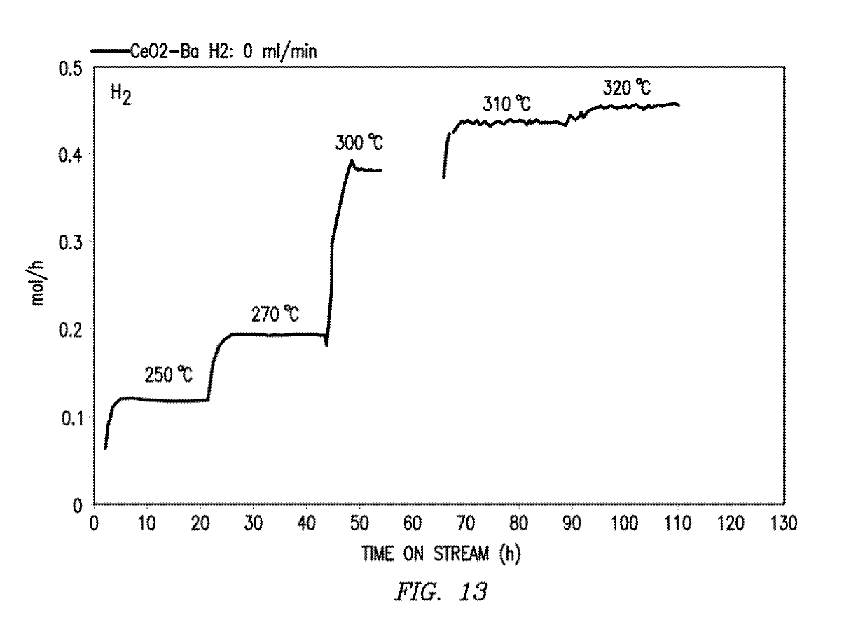

26Ni10Cu1Au1K15CeO₂Al2.5Ba, was used to reform a mixture of aqueous oxygenates containing methanol, ethanol, and isopropanol to produce H₂, CH₄, CO and CO₂ in the absence of hydrogen co-feed. FIGS. 13 through 16 depict the evolution of H₂, CH₄, CO and CO₂ as a function of temperature during the reforming of a mixture of aqueous oxygenates over 26Ni10Cu1Au1K15CeO₂Al2.5Ba, indicating reasonable catalytic activity at temperatures below 650K. The operating pressure was 300 psig, the liquid feed rate was 0.25 ml/min, the feed nitrogen was 500 ml/min, the weight of the catalyst was 4 grams, and the steam to carbon ratio was maintained at 3.

FIG. 13 depicts the evolution of H₂ as a function of temperature during the reforming of a mixture of aqueous oxygenates over 26Ni10Cu1Au1K15CeO₂Al2.5Ba.

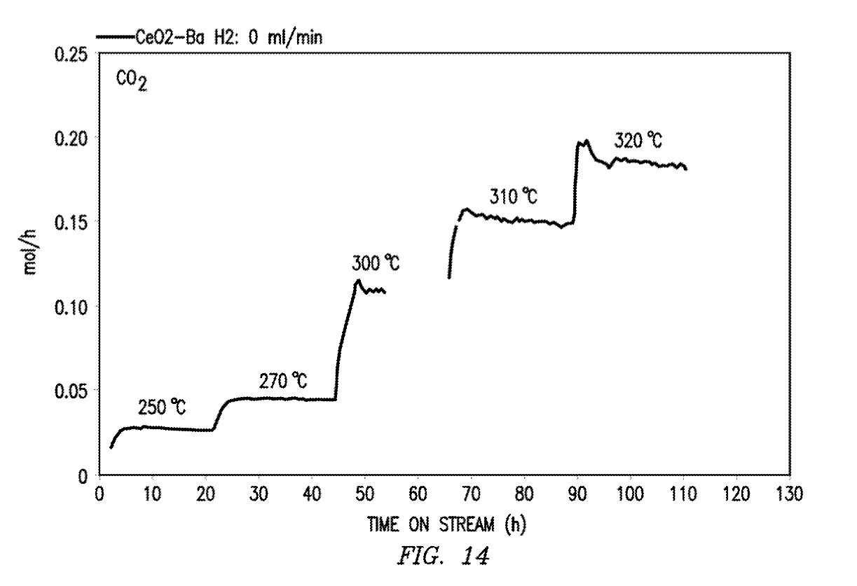

FIG. 14 depicts the evolution of CO₂ as a function of temperature during the reforming of a mixture of aqueous oxygenates over 26Ni10Cu1Au1K15CeO₂Al2.5Ba.

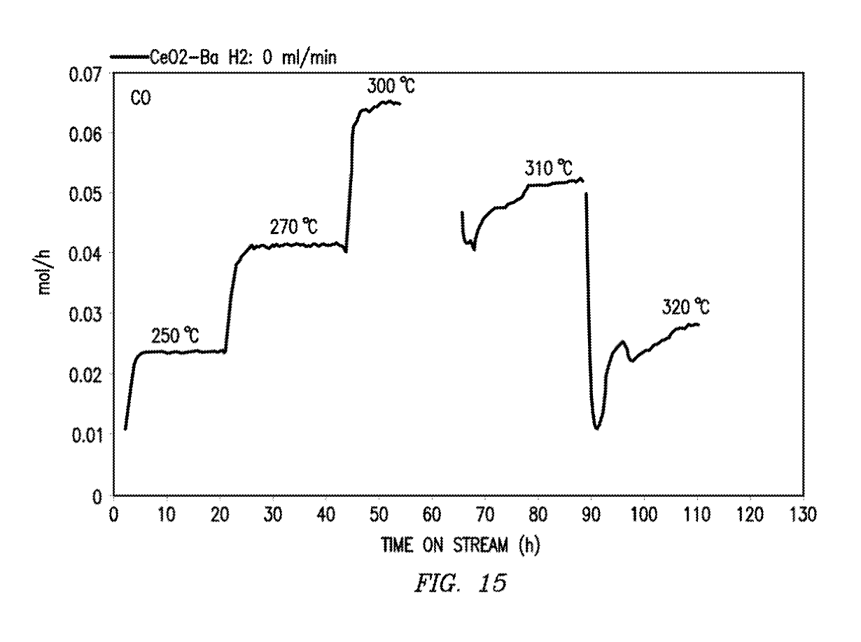

FIG. 15 depicts the evolution of CO as a function of temperature during the reforming of a mixture of aqueous oxygenates over 26Ni10Cu1Au1K15CeO₂Al2.5Ba.

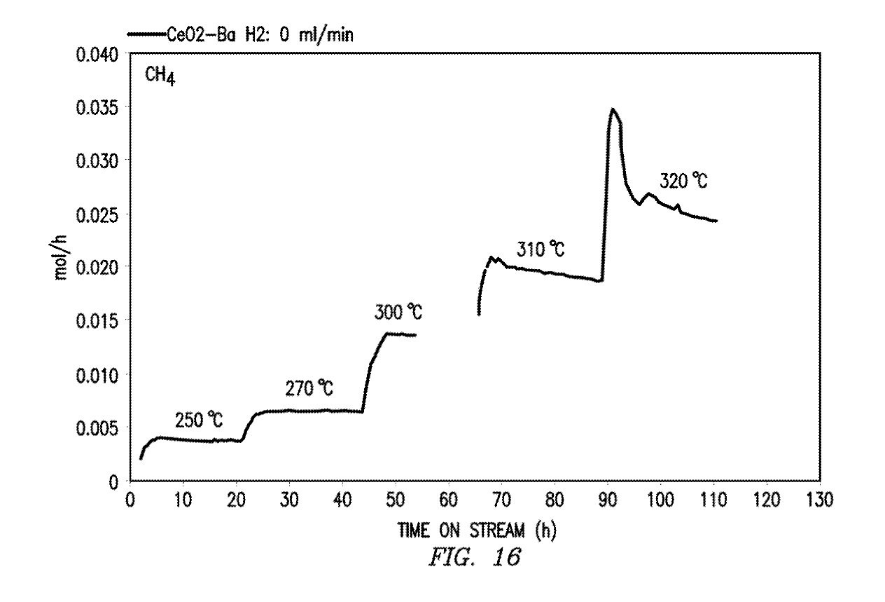

FIG. 16 depicts the evolution of CH₄ as a function of temperature during the reforming of a mixture of aqueous oxygenates over 26Ni10Cu1Au1K15CeO₂Al2.5Ba.

### EXAMPLE 3

26Ni10Cu15MgO₂Al2.5Ba, consisting of 26 wt % Ni, 10 wt % Cu, 15 wt % MgO, 2.5 wt % Ba and balance Al₂O₃ was used to reform a mixture of aqueous oxygenates containing methanol, ethanol, and isopropanol to produce H₂, CH₄, CO and CO₂.

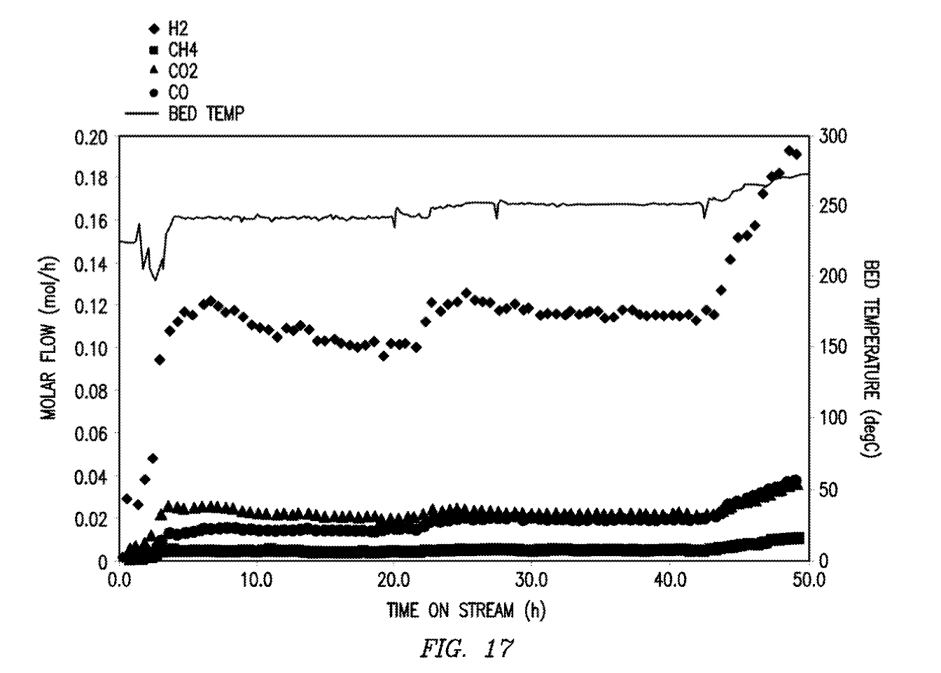

FIG. 17 depict the evolution of H₂, CH₄, CO and CO₂ as a function of temperature during the reforming of a mixture of aqueous oxygenates over 26Ni10Cu15MgO₂Al2.5Ba, indicating reasonable catalytic activity at temperatures below 650K. The operating pressure was 350 psig, the liquid feed rate was 0.25 ml/min, the feed nitrogen was 500 ml/min, the weight of the catalyst was 4 grams, and the steam to carbon ratio was maintained at 3.

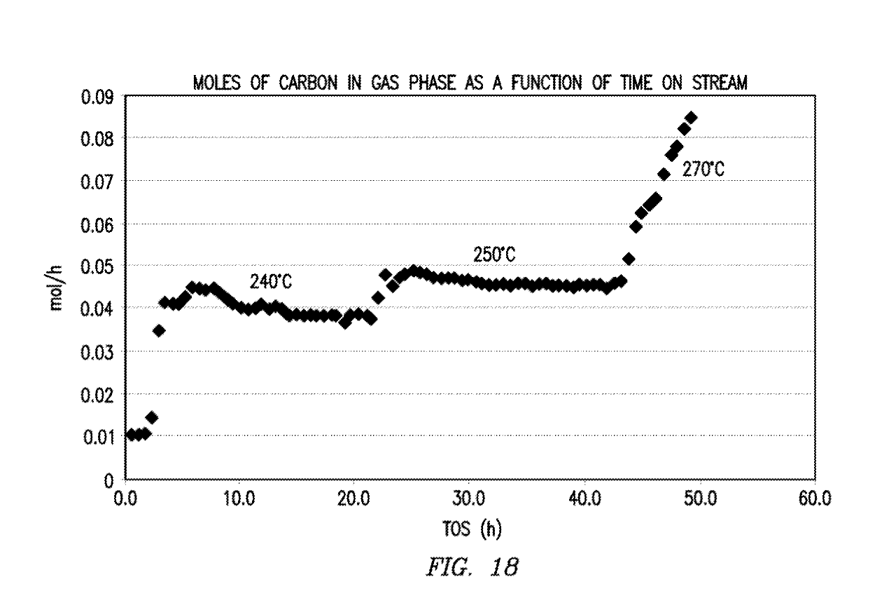

FIG. 18 depicts molar production rate of dominant gas phase carbon-containing species as a function of time on stream.

### EXAMPLE 4

A mixed oxygenate feed containing:

| Molecules | Composition (wt %) |
|---|---|
| Water | 64.85 |
| Methanol | 28.84 |
| Ethanol | 2.84 |
| 2-propanol | 2.36 |
| 1-propanol | 0.36 |
| Other oxygenates | 0.75 |

was flowed over a two different types of catalyst bed.

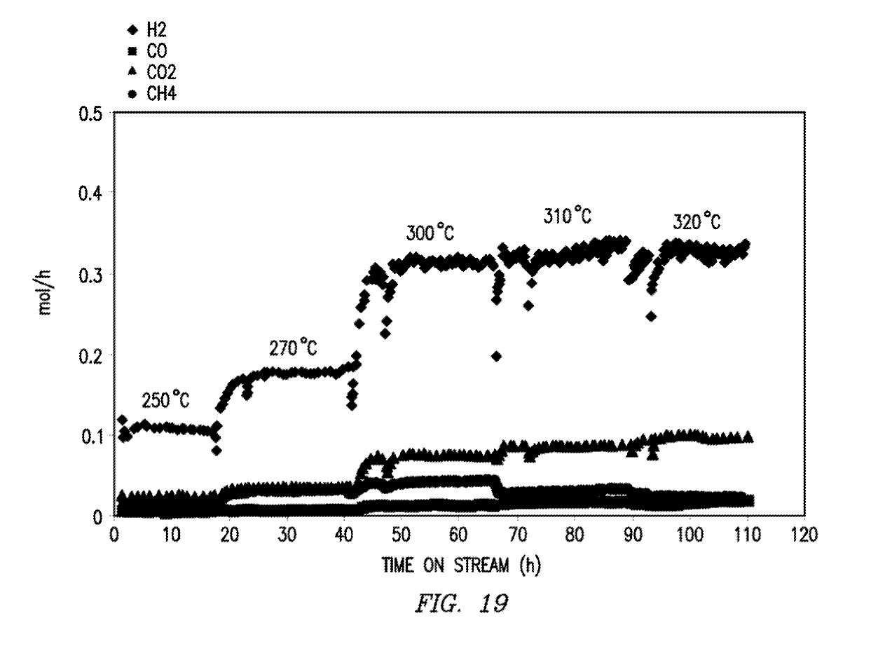

FIG. 19 depicts the performance of 13Ni5Cu1K2Zn on ceria modified alumina support during the conversion of mixed oxygenate feed at (H₂O:C of 2.3). The reaction was carried out at 300 psig and a liquid hourly space velocity of 1.875 hr⁻¹ in constant flow of nitrogen at 500 sccm.

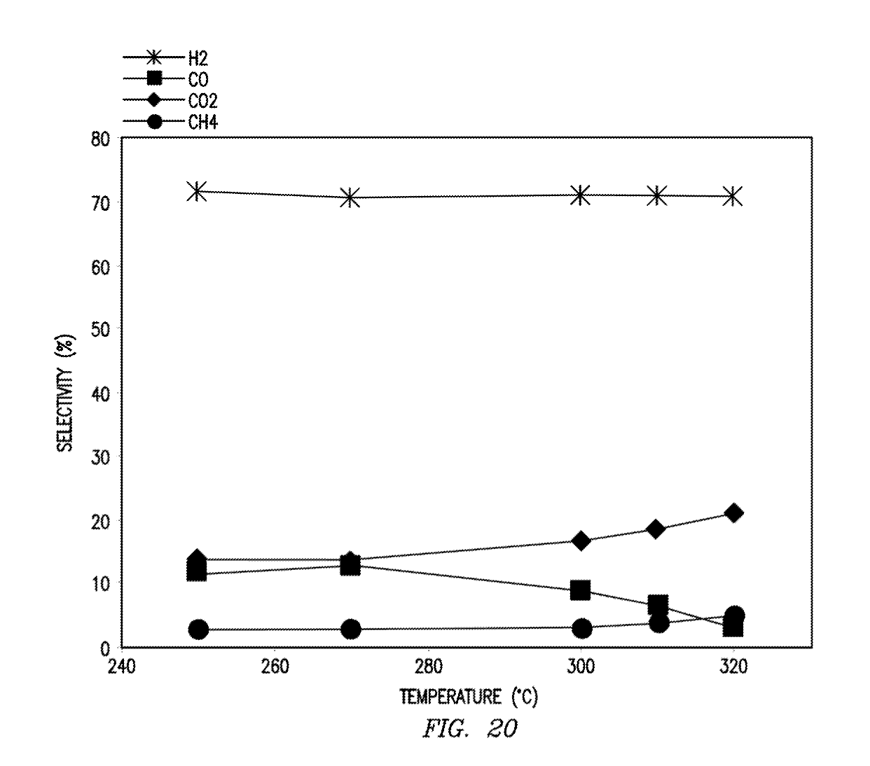

FIG. 20 depicts the average molar flow of the gas phase products evolution at different reaction temperatures for 13Ni5Cu1K2Zn catalyst on a ceria modified alumina support during the conversion of mixed oxygenate feed at (H₂O:C of 2.3). The reaction was carried out at 300 psig and a liquid hourly space velocity of 1.875 hr⁻¹ in constant flow of nitrogen at 500 sccm.

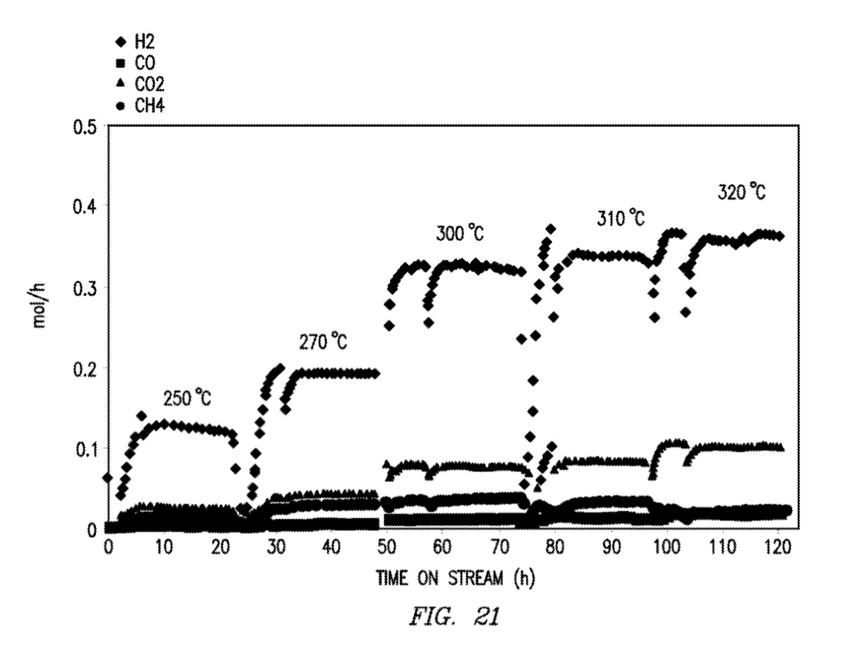

FIG. 21 depicts the performance of 13Ni5Cu1K4Zn on ceria modified alumina support during the conversion of mixed oxygenate feed at (H₂O:C of 2.3). The reaction was carried out at 300 psig and a liquid hourly space velocity of 1.875 hr⁻¹ in constant flow of nitrogen at 500 sccm.

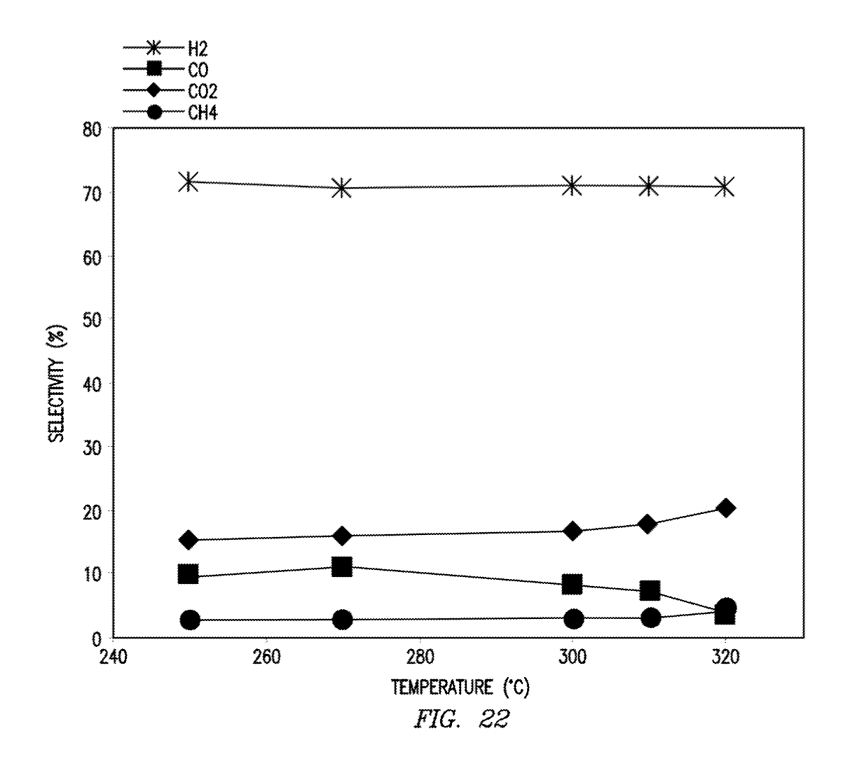

FIG. 22 depicts the average molar flow of the gas phase products evolution at different reaction temperatures for 13Ni5Cu1K4Zn catalyst on a ceria modified alumina support during the conversion of mixed oxygenate feed at (H₂O:C of 2.3). The reaction was carried out at 300 psig and a liquid hourly space velocity of 1.875 hr⁻¹ in constant flow of nitrogen at 500 sccm.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A catalyst for steam reforming, comprising:
an active site consisting essentially of NiCu or NiCuZn, from about 15 wt % to about 25 wt % of the catalyst;
a composition comprising at least one promoter and at least one support modifier, from about 15 wt % to about 25 wt % of the catalyst; and
a support.

2. The catalyst of claim 1, wherein the composition comprises three different components.

3. The catalyst of claim 1, wherein the composition comprises an alkaline earth metal.

4. The catalyst of claim 1, wherein the composition comprises an alkaline earth metal from about 0.1 wt % to about 5 wt % of the catalyst

5. The catalyst of claim 1, wherein the composition comprises a rare earth element.

6. The catalyst of claim 1, wherein the composition comprises a rare earth element from about 13 wt % to about 23 wt % of the catalyst

7. The catalyst of claim 1, wherein the composition comprises an alkali metal.

8. The catalyst of claim 1, wherein the composition comprises an alkali metal from about 0.1 wt % to about 5 wt % of the catalyst

9. The catalyst of claim 1, wherein the composition comprises an alkaline earth metal, a rare earth metal and an alkali metal.

10. The catalyst of claim 1, wherein the promoter contains K.

11. The catalyst of claim 1, wherein the support modifier contains Ce.

12. The catalyst of claim 1, wherein the support modifier contains Ba.

13. The catalyst of claim 1, wherein the support modifier contains Mg.

14. The catalyst of claim 1, wherein the promoter contains Au.

15. A catalyst for steam reforming, comprising:
an active site consisting essentially of NiCuZn or NiCu;
a composition consisting essentially of KCeBa; and
an alumina support.

16. The catalyst of claim 15, wherein the active site contains from about 15 wt % to about 25 wt % of the catalyst.

17. The catalyst of claim 15, wherein the composition contains from about 5 wt % to about 30 wt % of the catalyst.

18. A catalyst for steam reforming comprising:
an active site consisting essentially of: from about 12 wt % to about 14 wt % of Ni, from about 4 wt % to about 6 wt % of Cu and from about 1 wt % to about 3 wt % Zn;
a composition consisting essentially of: from about 0.1 wt % to about 2 wt % K, from about 17 wt % to about 19 wt % Ce and from about 0.1 wt % to about 2 wt % Ba; and
an alumina support.

19. A catalyst for steam reforming comprising:
an active site consisting essentially of: from about 12 wt % to about 14 wt % of Ni and from about 4 wt % to about 6 wt % of Cu;
a composition consisting essentially of: from about 0.1 wt % to about 2 wt % K, from about 17 wt % to about 19 wt % Ce and from about 0.1 wt % to about 2 wt % Ba; and
an alumina support.
